(19) United States
(12) Patent Application Publication
(10) Pub. No.: US 2018/0259015 A1
(43) Pub. Date: Sep. 13, 2018

(54) Wellhead Drive Brake

(71) Applicant: Ener Tools S.A., Buenos Aires (AR)

(72) Inventors: Juan I. Zubiri, Buenos Aires (AR); Carlos Caunedo, Buenos Aires (AR); Nicolas Pontelli, Buenos Aires (AR); Lucas Young, Buenos Aires (AR)

(21) Appl. No.: 15/973,786

(22) Filed: May 8, 2018

Related U.S. Application Data
(63) Continuation of application No. 13/767,532, filed on Feb. 14, 2013, now abandoned.

(30) Foreign Application Priority Data
Feb. 15, 2012 (AR) P120100503

(51) Int. Cl. F16D 57/02

(52) U.S. Cl. CPC F16D 57/02

(57) ABSTRACT

A braking arrangement for drive heads or pump heads, to be preferably used in a progressing cavity pump (PCP) system in oilfields, consisting of at least one disk moving inside a viscous fluid and facing a static disk, in which mechanical energy is transformed into heat. The viscous brake is a device acting as a function of the rotation speed, in which a higher speed generates a higher braking power caused by the increase of friction among the disks and the fluid. The arrangement may comprise more than one mobile and static disk assemblies, as well as a hollow axis instead of a solid one, to allow housing the pumping rod inside the axis, and may also comprise an anti-reverse bearing.

### CROSS REFERENCE TO RELATED APPLICATION

The present application claims benefit under Paris Convention from Argentine Patent Application Ser. No. P 2012 01 00503, filed Feb. 15, 2012.

### BACKGROUND

The present invention is directed to a braking arrangement for drive heads or pumping heads for progressing cavity pump (PCP) systems, used in the oilfields.

A drive head or PCP pumping head is a machine intended to transmit rotary movement of the motor to the pumping rods, in the same clockwise direction. There are several ways of achieving this, among which the following can be mentioned: a) pulleys and belts; b) gears; direct transmission (generally by using a synchronic motor). The head has axial bearings in order to be able to support the pumping rods, which can weigh several tons.

Drive heads are an important part of the PCP pumping system and, therefore, are indispensable in these. They are used in the process of oil production. First, the oilwell bore is made, and then the zones of interest are punched, and lastly the oilwell is completed by means of an artificial extraction system. In PCP pumping, the basic PCP pumping components are mainly: a PCP pump, a drive head and a motor.

The drive head is also responsible for stopping the rods when torsion is returned. This happens because, while the system is functioning normally, the rods accumulate mechanical torque and tend to wind up. When the motor stops, the rods find no rotary resistance any longer and therefore tend to liberate the accumulated rotary torsion in a most violent way, that is, causing a nearly instant braking jerk. This movement is called “backspin” and is in an anti-clockwise direction. The PCP pump operation for extracting oil is simple; while the rotor spins eccentrically inside the stator sealed cavities are formed between the surface of both, in order to move the fluid from the pump's suction port to the output port

The stator is placed at the bottom of the well threaded to the production tubing. The rotor is threaded to the rods by means of the spacer or intermediate connector, the rods being those elements that transmit the movement from the ground surface to rotor head. The geometry of the assembly is such that a series of identical separated cavities are formed. When the rotor turns inside the stator, these cavities move axially from the bottom of the stator towards the output port, by which the progressing pumping effect takes place. Since the cavities are hydraulically sealed one from the other, the pumping results in a positive displacement type.

### BACKGROUND OF THE INVENTION

Several adaptations have been developed in the field of wellhead drive brake systems since the earliest times. One of the first systems was based on unidirectional bearings, commonly known as mechanical brake. The issue was that it blocked the pumping rods without liberating their accumulated torsional energy.

Nowadays, the most commonly used braking system is the caliper/disk systems, just like the one used in the car wheels. Here again, this system is only a conventional braking system adapted to the usage in the field of Progressing Cavity Pumps (PCPs). The difference of this system is mainly its driver, which is based on the usage of a braking manifold having valves that regulate or control the hydraulic oil pressure applied to the caliper, by which a permanent and dynamic friction is obtained or, in other cases, an intermittent and static friction may be obtained.

Other type of braking systems may be the following:

Hydraulic Motor Braking

In this type of system, the pumping head is driven by the hydraulic motor, which in turn acts as braking arrangement when needed. A hydraulic motor can be used to rotate in both directions, driven by hydraulic oil in a closed system. When braking action is needed, a predefined controlled quantity of hydraulic oil is returned through the system, thereby generating a resistance created by the fluid flow, and due to this action the system is prevented from accelerating.

Brake Shoe Braking (Drum Brake Type)

It is, in concept, similar to the disk/caliper brake; instead of generating pressure on a mobile disk, the drum rotates for generating pressure against a backing plate. This type of system is an adaptation taken from vehicle braking systems, in which the adaptation consists of letting the system act with the centripetal force produced by the drive head acceleration. Therefore, with a greater acceleration, the brake shoes are further pushed generating friction against the external stator body. The brake shoes are immersed in an oil bath, thus allowing lower friction.

Paddle Braking

The system consists of an axis containing retractable paddles which retract, when the system rotates in a clockwise direction, thus generating a minimum resistance on the oil in which it is immersed. The oil is also useful for lubricating the drive head bearings. When needed, the paddles which contain holes open wide due to the effect of the oil on them and generate movement resistance due to the restricted fluid path of the oil through the holes.

Pending Issues Found in the Devices and Methods of Prior Art

The problems of each of the above mentioned systems are different and may be summarized as follows:

Disk/Caliper Braking Arrangement

The caliper contains the brake pads which are worn out due to the friction of continuous usage generated against the disk. It requires periodic maintenance servicing and it is known that in some cases the high temperatures of the fractioning elements has set them on fire. Also, the manifold uses valves which include very small holes that might get clogged with dirt particles. In order to avoid this, filters are usually used, but these also require permanent maintenance servicing and may also fail. Also, the system acts independently of the rod rotation speed when the torque is counteracted, which turns the braking system less efficient.

Hydraulic Motor Braking Arrangement

The system contains a great number of elements required for functioning correctly: a hydraulic pressure generator, high pressure hoses, sealing systems, among others. This great number of elements might result in high costs and also usually deteriorate with time, by which may trigger system failures due to the loss of system pressure.

Brake Shoe Arrangement

The brake shoes suffer wearing out and emit material due to the abrasion of the shoe against the backing plate's wall, thus developing particles in suspension in the surrounding air. These systems are difficult to be controlled and may cause problems in the braking system. The lubricating oil used in the bearings is the same one as the one used in these arrangements and this might cause a problem if both get mixed. Also, it is not easy to control de braking power and the parts forming the system must be replaced in order to generate more or less resistance to the centripetal force.

Paddle Braking Arrangement

This system does not allow regulating the braking intensity; also the paddles may fail due to the high torsion force developed at their linkage points.

### INTERNATIONAL PRIOR ART ANALYSIS

Document WO 97/10437 (20 Mar. 1997) describes braking system consisting of a fluid pump driven by a slippage clutch. The clutch transmits torque in one direction and slips in the opposite one. The fluid is sucked by the pump from a container to a restriction, and back to the container. The restriction creates a load against the pump's action and the latter uses the energy accumulated in the system.

Document U.S. Pat. No. 6,241,016 B1 (5 Jun. 2001) discloses the use of a gear pump for dissipating energy. In one direction the pump does not suck hydraulic liquid and, therefore, does not take up energy. In the opposite direction, the pump sucks liquid from a container and sends it back to the same through a flow restriction.

Document US 2002/0175029 A1 (28 Nov. 2002) uses a disk/caliper brake driven by a bidirectional pump that injects liquid only in one direction to the caliper, thereby driving the brake system. In the opposite direction the liquid is recirculated (without activating the braking mechanism), and this allows purging any air bubble present in the system.

Document US 2002/0185344 A1 (12 Dec. 2002) discloses a hydraulic clutch.

Document US 2001/0050168 A1 (13 Dec. 2001) describes a braking centrifugal system placed at the input axis but does not explain the way the braking system works.

Other documents related to this technical matter are: US 2005/163640 A1 (28 Jul. 2005); US 2005/0045323 A1 (3 Mar. 2005); US 2001/0050168 A1 (13 Dec. 2001); US 2005/205249 A1 (22 Sep. 2005); US 2007/0292277 A1 (20 Dec. 2007); US 2008/0060819 A1 (13 Mar. 2008); US 2010/0322788 A1 (23 Dec. 2010); CA 2582651 A1 (14 Aug. 2008); CA 2716430 A1 (9 Dec. 2001).

Unlike the braking systems of the prior art, the braking system of the present invention is a viscosity based brake, which consists basically of one or more disks moving inside a viscous media, transforming mechanic energy in heat. This is achieved by the shear resistance generated on the disk/disks plane surfaces.

The principles of operation of the brake of the present invention and of those of automatic shift gears have certain similarities because all of them are viscous engagements. A torque converter (automatic shift gear) or a viscous engagement (for example: Ferguson type) transmit torque in an attempt to equalize the input speed with the one at the output. The same happens in a viscous brake, only that one of the speeds is null. From there onwards, all other features set them apart in a noticeable way because the shift gears supply different torque/revolution rates according to different situations which the engine is submitted to, or due to the vehicle driver's selection. However, the work done by the viscous brake of the present invention does not change the mentioned rate because it only intends to lower the axis rotation from a number of revolutions to a full stop.

### SUMMARY OF THE INVENTION

The developed braking arrangement is mainly based on the friction among disks that are in contact with a viscous fluid. The viscous fluid is a device acting as a function of the rotation speed, in which a higher speed creates a higher braking action because the friction among the disks and the viscous fluid increases, thus transforming the mechanical energy into heat. The system may comprise more than one mobile arrangement formed by mobile and static disks, and may as well comprise a hollow axis instead of a solid one. If the axis is hollow, it might allow the pumping rod pass through it.

The way a viscous braking arrangement operates is variable and depends on: fluid viscosity, disk separation and disk surface.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1A shows the way brake parts work, and in detail the placement of each of these.

FIG. 1B shows a cutaway view through line B-B of FIG. 1A.

FIG. 2 shows a crosswise cutaway view of the arrangement of the present invention.

FIG. 3 shows an explosion view in detail of the components of the braking head indicating the required quantities of each of these.

### DETAILED DESCRIPTION OF THE DRAWINGS

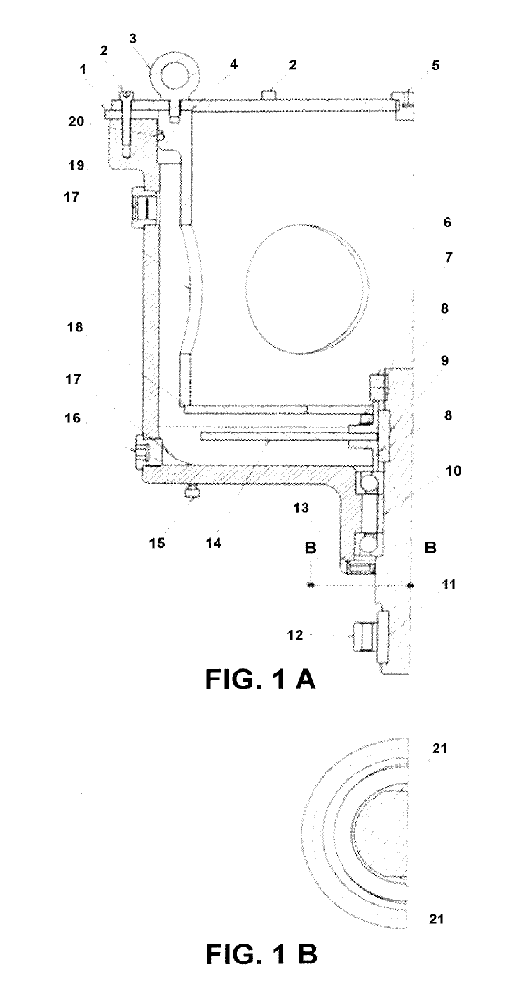

FIG. 1A shows a preferred embodiment of the present invention in which it may be seen a supplementary positioning base 1 that allows changing height h1 and also screw 2 that sets the position and adjusts the lid-separator-housing arrangement. Next to it may be seen eyebolt 3 that allows raising the bake arrangement. In a lower position it may be seen slot 4 that makes it easier the soldering of the internal cylinder to the lid. The plug 5 for covering the fluid loading port is shown at the upper end, and at one side the nut and the locking nut 6 make pressure on the mobile disk/bearings arrangement, and below these may be seen the screw 7 that locks the mobile disk and its support. At one side of it may be seen the mobile-disk holder 8 that engages the mobile disk to the axis and the pin 9 that avoids rotational movement of the mobile disk support. In a lower position it may be seen the bearing spacer 10 which decreases the torque absorbed by the bearings. At a lower end it may be seen the pin 11 which prevents the rotational movement between the anti-back-movement bearing 12 and the brake axis. In slightly higher position it may be seen a packing 13 that seals to avoid fluid losses and at the central portion the mobile disk 14 may be seen, that transmits the shear stress to the fluid. Screw 15 engages the brake to the reduction gear box and the plug 16 allows emptying the fluid through element 17 that helps its flow. Above disk 14 it may be seen that slot 18 helps the soldered bond of the internal cylinder to the static disk. The fluid level may be visually verified through both apertures (oxeyes) 19 placed at 90° one from the other, so that the brake's fluid level may be verified when it is not operating, even in a slanted position. In a higher position it may be seen an O-ring 20 that seals any possible fluid leak.

FIG. 1B shows a cutaway view through line B-B of the arrangement of FIG. 1A, in which a slot 21 allows fastening the axis when mounting and dismounting it and pre-stressing the mobile disk/bearing arrangement.

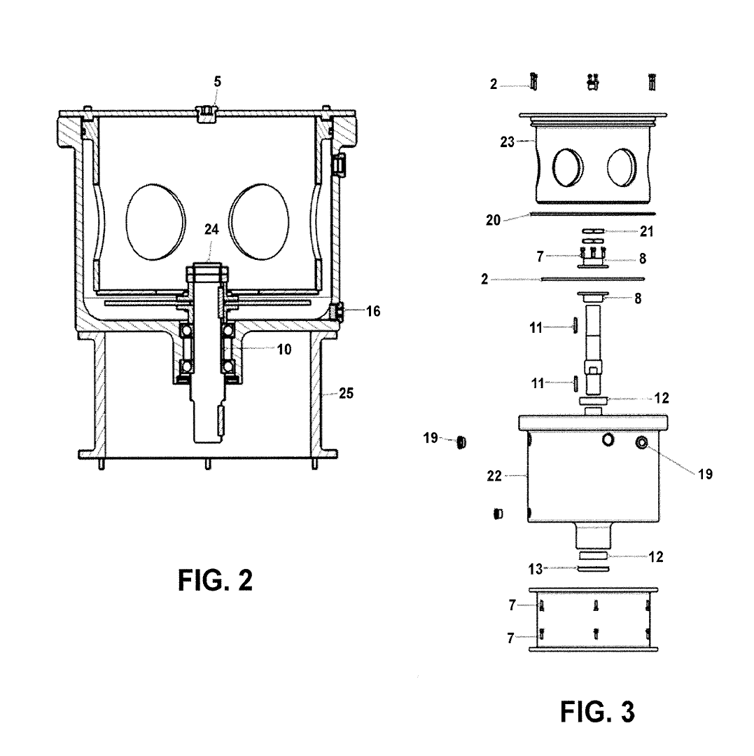

FIG. 2 shows a cutaway cross view of a preferred embodiment of the brake arrangement in which it may be seen plug 5 at its upper lid, the bearing spacer 10 at its lower portion, emptying plug 16 at one side, the central axis 24 of the brake, and the brake support 25.

FIG. 3 is an explosion view of a preferred embodiment of the present invention showing screws 2 which are preferably Allen (ANSI M6x1x35), screws 7 which are preferably Allen (ANSI M6x1x25), the mobile disk support 8, pins 11, ball bearings 12 which are preferably type SKF® 7208 BECBJ, packing 13 preferably type DBH 8804 Mx, mobile disk 14, oxeye 19, O-ring 20 preferably of a type Parker N2-383, adjusting nut 21, break housing 22 and the lid/brake arrangement 23.

The developed brake arrangement is mainly based on the friction among disks making contact through a viscous fluid. The viscous brake is a device that operates as a function of rotation speed, in which a higher speed produces a greater braking effect because the friction among the disks and the viscous fluid increases, transforming the mechanical energy into heat. The arrangement may comprise more than one mobile and static disk sets, and may have a hollow axis instead of a solid one, thus allowing that the pump rod goes operates through it.

The way a viscous braking arrangement operates is variable and depends on: fluid viscosity, disk separation and disk surface.

The braking effect is created by the rotation of mobile disk 14, also called “rotor” and which is immersed in a viscous environment. The axis must be connected to the movement transmission elements of the progressing cavities pump. These elements may be implemented with gears, belts, pulleys, in direct transmission, or any other way that allows transmitting rotational movement of the parts involved. This is most important for the moment in which a true backspin control is required. The braking effect is given by the shear stress generated in the fluid in contact with the disk surface, because it is enclosed in a reduced closed space. It is very important to keep this effect is under control because the braking power depends very tightly on the distance between the housing's wall and the disk.

When the brake is activated, the fluid tends to rotate at the same angular speed as the disk. In this way, if no slippage occurs between the surfaces, the fluid in contact with the mobile disk will have the same speed as the disk's periphery and the fluid in contact with the housing will be still. The speed gradient resulting in the fluid layer generates the shear stress already mentioned to cause the braking effect.

The braking power of the developed arrangement depends on the following factors:
Rotor's geometry
Disk diameter
Rotation speed
Fluid type
Mainly, density and viscosity
Number of disks to be used

The braking power is inversely proportional to the free space between the disk and the housing. In other words, a smaller free space allows greater braking power and vice versa. A small change in the free space is enough for obtaining a great change in braking power.

The main features of the brake's design are its reliability, toughness and simplicity.

Placement of the Brake

The pumping head has a reduction gearbox linking the motor axis with the pump rod, for speed reduction in the motor-to-rod direction and increases it in the opposite direction. Therefore, based on the principle of power conservation, it may be affirmed that at the motor axis there is always a higher rotation speed than at the polished rod.

Since the backspin effect is not exceptional, the angular speed at the motor is also greater when this effect takes place than. This situation has an important consequence: the viscous brake will be capable of applying a greater braking torque if applied at the polished rod (in this case using a hollow rod). It is so because the braking torque depends directly on the rotation speed, and therefore will be so many times greater as the transmission multiplication relation.

In a preferred embodiment, the braking arrangement is connected by means of an anti-reverse bearing, which should allow rotation in one direction and block the internal ring with the outer one in the opposite rotation direction.

An anti-reverse (or unidirectional) consists of two rings or tracks and several balls or rollers in contact with both of those. Compared to a simple roller bearing, its difference is that it has the capacity of automatically connecting or disconnecting the inner and outer tracks, depending on the rotation direction. In this way, the braking action will take place without the need of any additional mechanism. The bearing is selected as a function of torque to be transmitted and the maximum admissible revolutions per minute.

Fluid Selection

The fluid is a fundamental element for establishing the braking power since it is the one that generates the shear forces that de-accelerate the system. It must be, at first, very viscous but also showing the following properties:
High dynamic viscosity (minimum 1,000 centipoise) and showing the highest possible high temperature stability.
High specific heat so that the heat generated by the braking effect does not increase its temperature too much.
Good heat transmission feature, that is, high heat transmission coefficient and high convection rate for dissipating in the surrounding environment.

It should not degrade with high temperature.

### ADVANTAGES OF THE PRESENT INVENTION

The system of the present invention does not generate wear-out of the static or rotating elements.

It increases the braking power as a function of the system's acceleration, allowing more efficient braking, that is, allowing the torque to disappear more quickly.

It does not require maintenance servicing of its parts.

The system is independent of the driving head gear and bearing lubrication fluids.

It allows adapting the braking power as a function of what is needed.

It reduces the number of components related with the braking arrangement.

It may be easily replaced when it fails.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A braking arrangement for pumping heads to be used in oil fields, comprising extraction pumps with movement transmission systems, the arrangement comprising:
an axis,
one or more disk pairs, one mobile and one static, submerged inside a viscous fluid, and
wherein said axis is connected with said movement transmission system of its corresponding extraction pump.

2. The braking arrangement according to claim 1, wherein said axis is hollow, by which the pumping rod may be installed inside it.

3. The braking arrangement according to claim 1, wherein the connection of said axis with the movement transmission system is made by means of gears.

4. The braking arrangement according to claim 2, wherein the connection of said axis with the movement transmission system is made by means of gears.

5. The braking arrangement according to claim 1, wherein the connection of said axis with the movement transmission system is made by means of belts and pulleys.

6. The braking arrangement according to claim 2, wherein the connection of said axis with the movement transmission system is made by means of belts and pulleys.

7. The braking arrangement according to claim 1, wherein the connection of said axis with the movement transmission system is direct.

8. The braking arrangement according to claim 2, wherein the connection of said axis with the movement transmission system is direct.

9. The braking arrangement according to claim 1, wherein the braking power is a direct function of the following parameters:
rotor geometry;
disk diameter;
rotation speed;
fluid density and viscosity; and
number of contained disks.

10. The braking arrangement according to claim 2, wherein the braking power is a direct function of the following parameters:
rotor geometry;
disk diameter;
rotation speed;
fluid density and viscosity; and
number of contained disks.

11. The braking arrangement according to claim 2, wherein the brake is engaged to the polished bar of the pumping rod placed inside the hollow axis.

12. The braking arrangement according to claim 11, wherein the brake is engaged to the polished bar of the pumping rod by means of an anti-reverse bearing.

13. The braking arrangement according to claim 12, wherein said anti-reverse bearing consists of two rings or tracks and several balls or rolls which are in contact both with those elements.

14. The braking arrangement according to claim 1, wherein said viscous fluid shows a dynamic viscosity of at least 1,000 centipoise.
